(19) United States
(12) Patent Application Publication
(10) Pub. No.: US 2005/0182641 A1
(43) Pub. Date: Aug. 18, 2005

(54) Collaborative information system for real estate, building design, construction and facility management and similar industries

(76) Inventors: David Ing, West Vancouver (CA); John Brown, Burnaby (CA); David Towert, Roberts Creek (CA); Casey Chamberlain, Vancouver (CA); Ming Zhang, Vancouver (CA); Peter Queenan, Coquitlam (CA); Tim Kent, North Vancouver (CA); Dan Gramer, Redmond, WA (US); Daniel Flippance, Vancouver (CA); Milan Veljovic, Burnaby (CA); John Bodrozic, El Dorado Hills, CA (US)

Correspondence Address: DLA PIPER RUDNICK GRAY CARY US, LLP, 2000 UNIVERSITY AVENUE, E. PALO ALTO, CA, 94303-2248, US

(21) Appl. No.: 10/941,366

(22) Filed: Sep. 14, 2004

Related U.S. Application Data
(60) Provisional application No. 60/503,608, filed on Sep. 16, 2003.

(51) Int. Cl. G06F 17/60

(52) U.S. Cl. 705/1

(57) ABSTRACT

A collaborative information system for the project management of large-scale real estate, design, construction, and facility management professionals. The system is designed to be used by the various different companies and sub-contractors involved in the planning, building and maintenance of a building or facility, and brings together a number of systems that include information storage, retrieval, workflow and business rules that provide a business process management solution through an innovative combination of distribution techniques. The system allows the storage of both the data relating to the project management as well as the best practices.

### RELATED APPLICATIONS

Priority is claimed to Provisional Application Ser. No. 60/503,608 filed on Sep. 16, 2003.

### TECHNICAL FIELD

Described is a computer based information system for the organization and management of real estate, design, construction, and facility management and similar documents and business processes. More specifically, the system relates to ways of collaborating between distributed people and computer systems using a document workflow metaphor while still offering traditional capabilities of data storage, retrieval and organization.

### SUMMARY OF THE INVENTION

The system is built around a series of computer signals constructed to revolve around a paper document based metaphor. The system takes the best practices of the real estate, design, construction, and facility management and similar industries and combines their business rules and structure in a novel way as a series of document types, business services and templates.

The document types contain the structure of standard forms and paper-based documents that make up the relevant industry's data capture requirements. The document types are a structured template on what information must be entered into the system. The documents are managed by the system by presenting with the document a series of tasks to work through in a way that progresses the document through a number of states.

We combine the structure of an information system with the collaborative abilities of an ad hoc communications system in a form similar to electronic mail. The combination of a task notice attached to the document allows the system to provide a set of rules for the work that needs to be done on that document to achieve a business aim.

The system rules that apply to the documents are managed through a series of configuration templates. The templates are a hierarchy of business rules and configuration that allows the user to set up the system to provide guidance in the best way to process the information in the document to achieve the business aim.

The collaborative communication metaphor within the system is used both to route information to other human users and also to route information to external computer systems for processing.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a block diagram that describes the elements that make up an illustrative document within the system.

FIG. 2 is a flowchart diagram that describes the elements of document state transition.

FIG. 3 is a block diagram that describes the elements that make up a document template and how that template relates to a document.

FIG. 4 is a flowchart diagram that describes the workflow elements of action and distribution management.

FIG. 5 is a block diagram that describes the configuration hierarchy of the templates used in the system.

FIG. 6 is a block diagram that describes the distribution of documents used in the system.

FIG. 7 is an illustration that describes in an example the way in which a Document is owned by separate organizations.

FIG. 8 is an illustration that describes in an example the Document states and the systems rules that are typically involved in a state transition.

FIG. 9.1 through FIG. 9.7 represent an illustration that describes in an example the way in which a Document moves between states as part of its communication and workflow.

FIG. 10 is an illustration that describes in an example the methods of Document communication that are typically involved in sending and receiving the system's information.

### DESCRIPTION OF THE PREFERRED EMBODIMENT

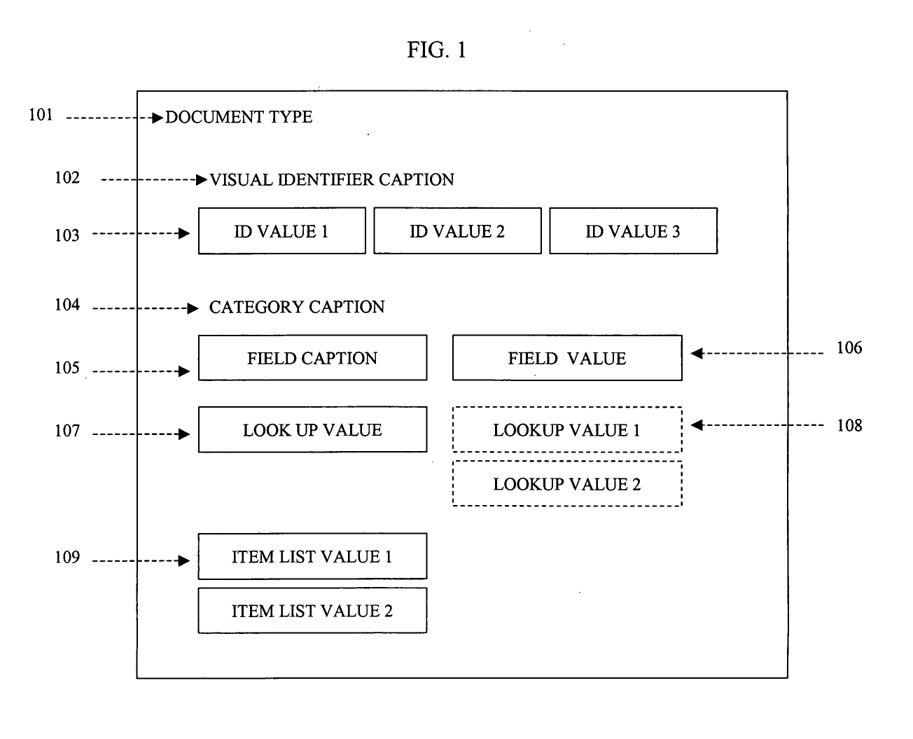

The system is built around the concept of a structured document relating to the real estate, design, construction, and facility management or similar industries. FIG. 1 illustrates the elements that make up a document, which can be considered to be in hard document or signal form. The system includes a series of Document Types that relate to the real estate, design, construction, and facility management or similar industries. The drawing elements are grouped together within a Document Type 101. The type is recognized throughout the system and is used to identify what semantic meaning should be attached to the stored document data.

The user identifies the document within the system by the normal use of the Visual Identifier Caption 102. The Visual Identifier Caption identifying text may be redefined as part of the system's configuration. The system is generally configured before a major project is undertaken and establishes the default rules and processes to be followed by the users. The Visual Identifier Caption rules include whether to make the default values a counter sequence or which parts of the Identifier need to be completed by the User when a Document is first created. The Visual Identifier Caption, like all captions in the system, may be internationalized in the system to present different labels and captions describing the meaning of the data in different languages. The Visual Identifier value is made up of at least three parts 103, here ID Value 1, ID Value 2 and ID Value 3 are examples, and can include meaningful values associated with the document by the user. The system tracks the document using the Visual Identifier which is used throughout the document's lifecycle as it goes to various users and external systems.

The document fields are the data values stored and retrieved as part of the document. The Category Caption 104 allows the system to present the information as a series of groups. The grouping term in the Category Caption helps describe a series of fields. The Field Caption 105 is the label used to describe the data value contained in the Field Value 106. The Field Caption can be configured by the user and may be internationalized in the system to present different labels and captions describing the meaning of the data in different languages. A document is primarily made up of a series of Field Values.

A specialization of a Field Value is a Look Up Value 107. A Look Up Value is an enumerated value which the user of the system chooses from a configurable list of acceptable data values. The Look Up Value enumerations 108, here Look Up Value 1 and Look Up Value 2 are examples, are configuration within the system that provides consistency of data entry which is invaluable in information reporting and analysis. Examples of Look Up Values include industry specific well-known lists values, e.g., ARCH would mean Architect, while ENG would mean Engineer. The Look Up Value can be configured as an enumeration placed with a hierarchy of another Look Up Values, for example, the Job Discipline Look Up Value would include ‘ENG’ meaning Engineer, which in term would include child the Look Up Values ‘ELEC’ and ‘MECH’ for Electrical and Mechanical Engineering respectively. Look Up Values in the system include a unique code, a description and a collection of user definable attributes which can be used to further describe the Look Up Value.

A specialization of a Field Value is an Item List Value 109, here Item List Value 1 and Item List Value 2 are examples. An Item List Value is a nested Field Value 106 in that it is considered part of the Document 101 but a structured subset of the data. An Item List Value may be a single Field Value or a series of Values. An Item List Value is used where the Document requires that an undetermined series of values needs to be entered into the system. The series total may be between 0 and n values.

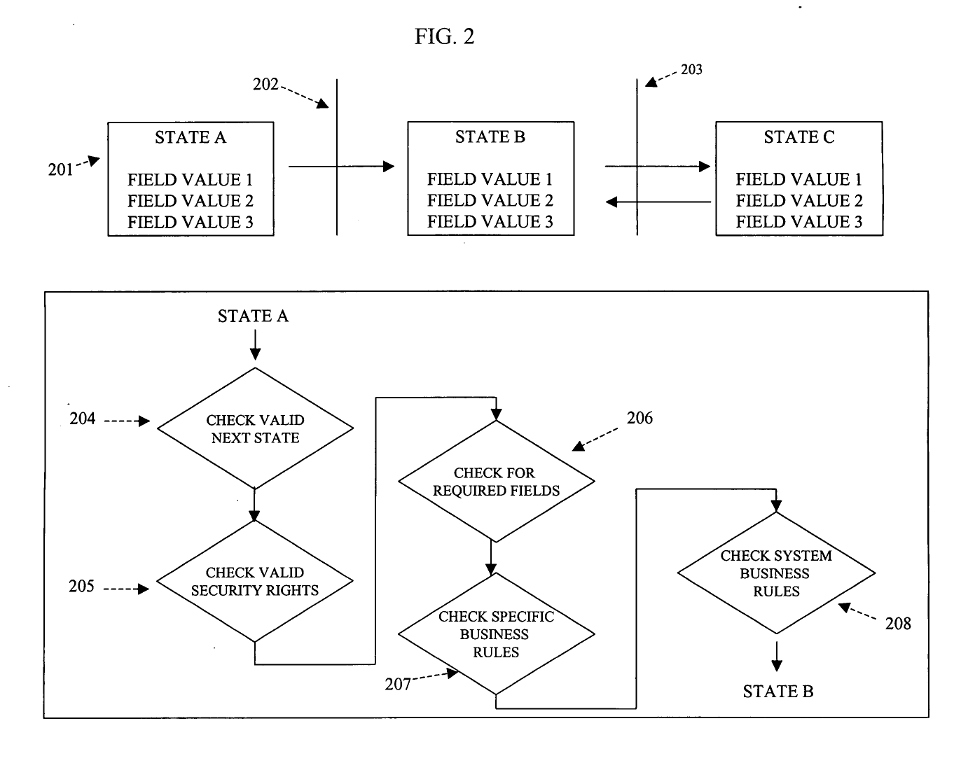

The system uses the previously described concept of a document to allow for a series of business steps to be placed on the document. The document steps or business processes are a series of state transitions as described in FIG. 2. The state transition represents the business workflow rules of a document. Each document state will contain a document that contains the elements described in FIG. 1. The Document starts in an initial state, State A at 201 and is logically moved to a new state, State B, through a process called a state transition 202. The state transition, for example, 203, of the document may return the document to a previously held state, State B, for example. The state transition of the document represents a business processing step that has been performed on the document. The rules for this business processing step are illustrated by a dataflow diagram that initially checks to see if the state transition is a valid one, at 204, as configured or defined by the user of the system. Any checks that fail will leave the document in its present state. The system checks that the document may leave the current state and enter the new one as the first rule check it performs. The system can be configured for each document type as to what state transitions are valid. Another business rule check is that the resource that initiated the action to request the state transition has the relevant security privileges, as at 205. The system allows for either human users or external computer systems to attempt a state transition of a document. The system next checks that the various document elements that are marked as required for the proposed state are completed, as at 206. Typical document elements to be marked as required include important dates, names, and currency values in the document. For example, a Purchase Order may require that the purchase date, amount and material description are completed by the user before the order is approved. The field values that are required are stored within the Document Template for the Document and are configurable by the user. This step ensures that the document has the correct data within it for the proposed state. The system then checks that the values within the document data conform to the business rules that have been setup in the system for the real estate, design, construction, and facility management industries, as at 207. Example rules would include a check that the data of the Document Field Values to verify if they are within the constraints built into the system, for example, Field Value 1 contains a date (10^{th} Jan. 1970) that must precede the Field Value 2 date. The system then checks that the System Business Rules are met for the proposed state transition, as at 208. An example of a System Business Rule would be a ‘Limit of Authority’ check, in which only privileged users may approve financial documents over a certain value. A field can be marked in the Document Template to indicate that the System Business Rule of Limit of Authority must be checked for the state transition to be successful. Any Document Type with this rule marked as enforceable will then be checked.

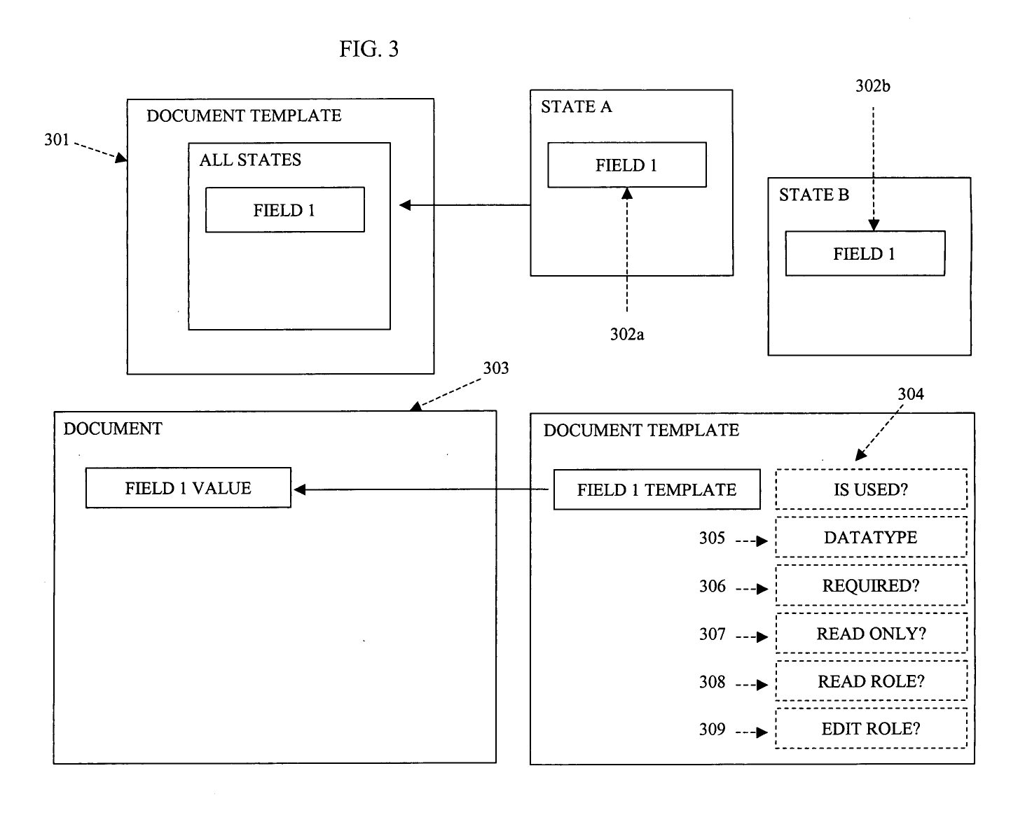

The Document progresses through a number of state transitions and the system uses the Document Template associated with the Document to check that it is a valid business process step. FIG. 3 describes the association between the Document and its Document Template. Each Document within the system has one Document Template 301. The Document Template contains a set of rules to apply to all states plus a series of rules to apply for each state, for example, 302a and 302b. The Document Template rules for each state override the values as defined for all states, if they are configured. For example, a Document Template may have the ‘Purchase Amount’ Document Field marked as ‘Required’ if it is to enter the ‘Purchase Approved’ state. For all other states of the document the value of this Document Field does not have to be completed unless it is trying to move into the ‘Purchase Approved’ state. The Document Fields are marked with rules for each Document Type element. For each Document Type Element there is a corresponding set of Document Template rules stored as at 303. The rules are used during the Document state transition described in FIG. 2. The rules within the Document Template contain the following set of rules. The first rule, 304, is a value of true or false regarding whether the Document Element is used by the system or not. The second rule, 305, is the enumeration describes the Value's data type. Examples include values such as real number, integer number, a date, a monetary value 305. The third rule, 306, is a value of true or false regarding whether the Document Element is required or not. The fourth rule, 307, is a value of true or false regarding whether the Document Element is allowed to be changed or not, for example describing if the value may be edited or is considered only for reading. The fifth rule, 308, is a value that describes the security role required by the resource performing the proposed action to be able to read the data value within the Document Element, for example a user without this security role would not be able to see the data value 308. The sixth rule, 309, is a value that describes the security role required by the resource performing the proposed action to be able to edit the data value within the Document Element, for example a user without this security role would not be able to change the data value. The rules are evaluated in the order described, as in, if any rule check fails then the action is not allowed, for example if the read only value 307 is true, then it overrides the ability to edit the value 309 as rule four precedes rule six.

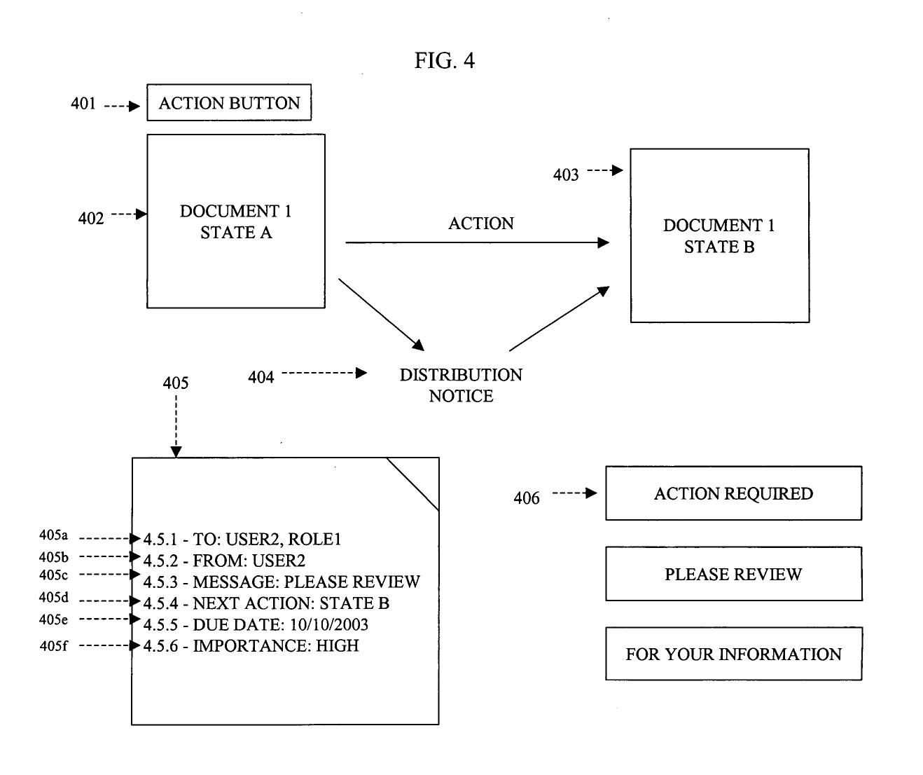

The document progresses through a business process relating to the real estate, design, construction, and facility management or similar industries in a series of state transitions that represent and contain a number of rules. The system increases the value of this ability by also including a way of communicating the documents within this framework to end users and external systems in a workflow metaphor called Action and Distribution Management. FIG. 4 describes the elements that make up the process of Action and Distribution Management as a way of communicating the Document information to end users and external systems. The initiating element within a Document state transition step is the Action Button 401. This represents a concept of either a user interface button to be pressed (or clicked) by the end user or an action initiated from an external computer system. The action initiated as illustrated by FIG. 4 shows the progress of the state transition of a Document in State A 402 to State B 403 through the use of an Action. The system uses the concept of a task notice, here called a Distribution Notice, to append additional information about the intention of transitioning between State A and State B. The system uses a metaphor of a Distribution Notice note, or task notice, that is attached to the Document to indicate the step that needs to be taken to the Document. The Distribution Notice represents the workflow collaboration of a document. FIG. 4 illustrates a Document already in State A and a Distribution Noticed appended to the Document showing what the desired next Action. The Distribution Notice contains a number of elements that the user or an external system can use to understand the intent and required steps to process the document. The elements contain the following data values. The first value is the description of who the system is indicating should receive the Document in State B 405a. The first value often contains examples such as the name of the user or a description of the role that a number of users on the system may have. The second value, 405b, is the description on the system is indicating who has sent the Distribution Notice requesting the Document transition from State A to State B. The third value, 405c, is a message that sets additional context on why the document should transition and any free-form information that would of value to facilitate the process. The third value is used with an enumeration of Distribution Notice types 406. The Distribution Notice types include, at a minimum, the values that categorize what the Distribution Notice is requiring from the user or external system. An example of this is where two users can receive the Document but with different actions in the Distribution Notice. For example User ‘A’ may be sent a Document with the Distribution Notice with the Message type 405c of ‘Action Required’ while a User ‘B’ may be sent a Document with the Distribution Notice with the Message type of ‘Please Review’. User ‘A’ would perform an action while User ‘B’ has just been informed of the process but takes no action. The fourth value, 405d, is a description that shows that the next desired state is to move the Document to State B. The fifth value, 405e, is a date corresponding to when the Action should take place by. This fifth value is used by the system to track progress of Document processing and can be used for reporting and analysis of progress of Documents through the business processes. The sixth value, 405f, is the enumerated value describing the importance or severity associated by the system to this Document state transition.

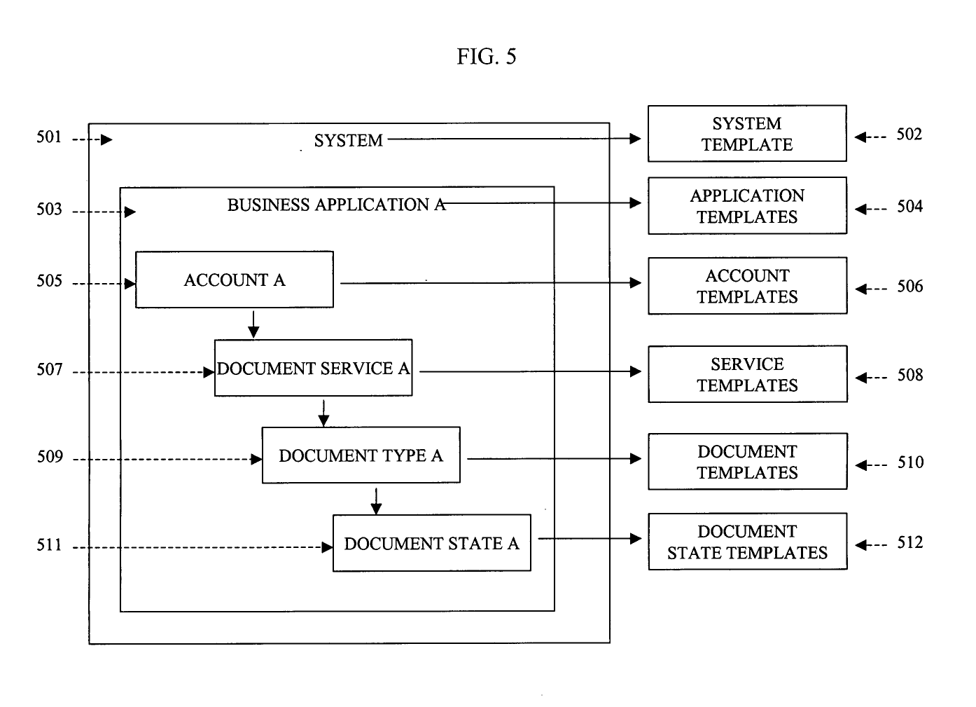

The system organizes the business process rules held within the Document Templates in a Configuration Template Hierarchy. FIG. 5 illustrates the way in which the system has a number of related levels of configuration templates. The templates' relationships to each level are described. The key concept is the way in which the details of the Document State Templates can be organized into larger grouping concepts of the Document Templates, which are then in turn held in Service Templates, and so forth. This novel Configuration Template Hierarchy allows the business processes in the real estate, design, construction, and facility management and similar industries to be easily controlled and improved. There are a number of template types within the configuration hierarchy. The first template level 502 is the System Template for the data considered to be system-wide, as at 501. This first template level provides default settings and rules data that applies through the entire system. The second template level 504 is the Application Templates for defaults rules and settings for the data in the specific business applications 503 provided in the system for the real estate, design, construction, and facility management industries. The Business Applications represent a grouping of Document Service functionality. The third level of template 506 is the Account Templates that provides the default rules and settings for the data in the specific accounts 505. The Accounts represent a collection of Documents related to a particular industry project, program or organization within the real estate, design, construction, and facility management industries. The fourth level of template 508 is the Document Service Templates that provides the default rules and settings for the data in the particular Document Service 507. The Document Service represents a group of functionality regarding particular Document Types that in turn relates to a group of Documents within an Account. A Business Application 503 contains a number of Document Services 507, although for clarity only one is shown in FIG. 5. The fifth level of template 510 is the Document Templates that relate to information within FIG. 3. The Document Template contains the rules and setting for a Document Type 509. A Document Service 507 contains a number of Document Types 509. The sixth level of template 512 is the Document State Templates that contain the rules and settings for a particular Document state. The use of the Document state rules and settings relate to information within FIG. 2. A Document Type 509 contains a number of Document States 511.

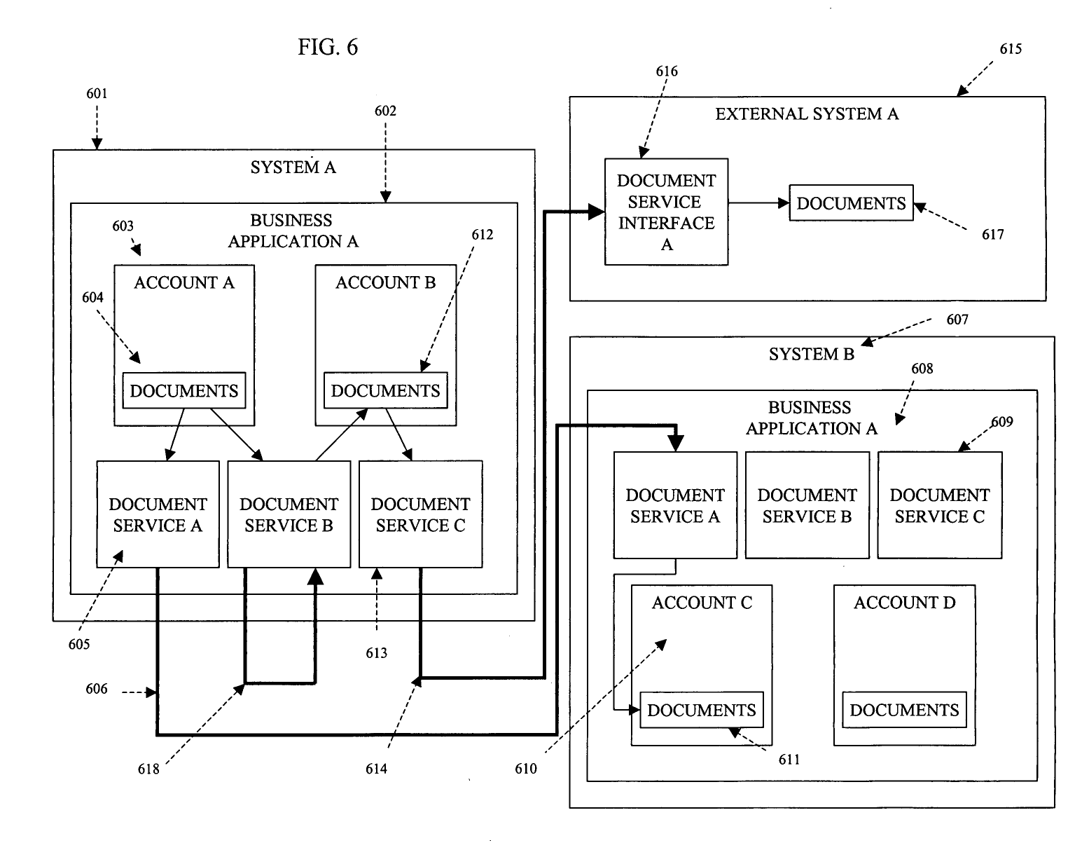

The system provides a number of unique ways to distribute the document data to either other Accounts running the same type of system or to external computer systems. FIG. 6 illustrates the structure of the system and illustrates a number of distribution examples. For example, it illustrates the way in which the system communicates the documents in a minimum of three ways. The first way is where a Document can be sent to another system either through a Local Area Network or Wide Area Network 606. The second way is where a Document can be sent to an external system through a Local Area Network or Wide Area Network 614. The third way is where a Document can be transfer from one local Account to another without leaving the System as at 618. The flow of the document through the system can be described in these three ways using the following drawing references. The System represents an installation of the computer system 601. The System contains at least one or more Business Applications 602 that related to the real estate, design, construction, and facility management or similar industries. The Business Applications contain one or more Accounts 603 of Document data 604 which are processed by a set of Document Services 605. FIG. 6 illustrates the first way of distribution in showing how a Document 604 is exported from the System 601 over a Local Area Network 614 or Wide Area Network 606 to another system 607, and it can be considered that System ‘A’ 601 is exporting the Document 604 with the Document Service A 605 from Account ‘A’ 603 while System ‘B’ 607 can be considered importing the Document via the Document Service A 609 into the Account ‘C’ 610 to store the document ‘copy’ 611. FIG. 6 illustrates the second way of distribution in showing how a document 612 can be exported via a Document Service ‘C’ 613 over a Local Area Network or Wide Area Network 614 to an external system, here External System A, 615, and it can be considered that System ‘A’ 601 is exporting the Document 612 with the Document Service ‘C’ 613 from Account ‘B’ while the external system ‘A’ 615 can be considered importing the Document via the Document Service Interface ‘A’ 616 to store the document ‘copy’ 617. FIG. 6 illustrates the third way of distribution in showing how a Document 604 can be sent via a Document Service 618 where the Document is transferred between Accounts but kept within the same system 601.

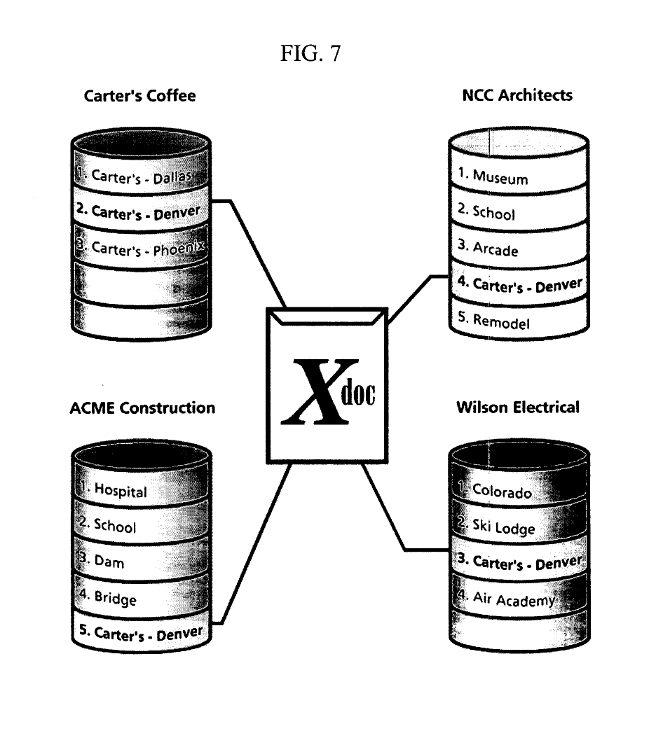

The system's method of distributing documents allows the data to be coordinated through a number of separate systems. FIG. 7 provides an example illustration where the document, shown as an ‘Xdoc’, belongs in four separate systems, shown as Carter's Coffee, NCC Architects, Acme Construction and Wilson Electrical respectively, but forms part of an overall bigger construction project, shown as Carter's Denver project. A large construction project involves a number of separate companies. In this example the construction of a building involves the companies of Carter, NCC, Acme and Wilson. These can be viewed as service entities or service providers. The Document data is sent and received between the four separate company's systems in the methods described in FIG. 6. The ‘Xdoc’ is representative of the Document described in FIG. 1. The separate systems are being used to collaborate on a single large construction project but still allowing the four separate companies to maintain both their own separate systems and copies of the Document data. The four companies may work on a number of construction projects at any one time, but this example shows how an owner of a building, Carter's Coffee, has employed a general contractor called Acme Construction to build their new Denver store. Acme Construction as the general contractor are also working with NCC Architects and Wilson Electrical who provide specialized services that help the overall aim of managing the construction project.

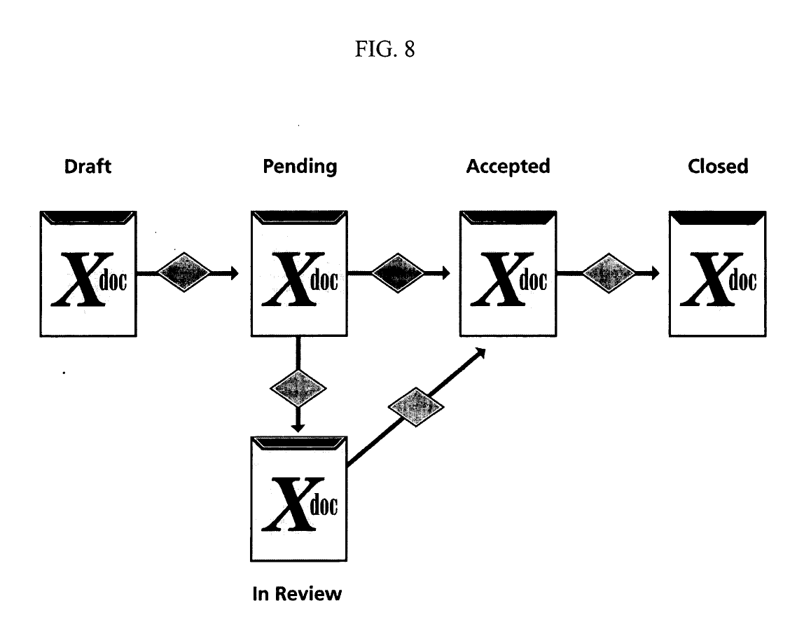

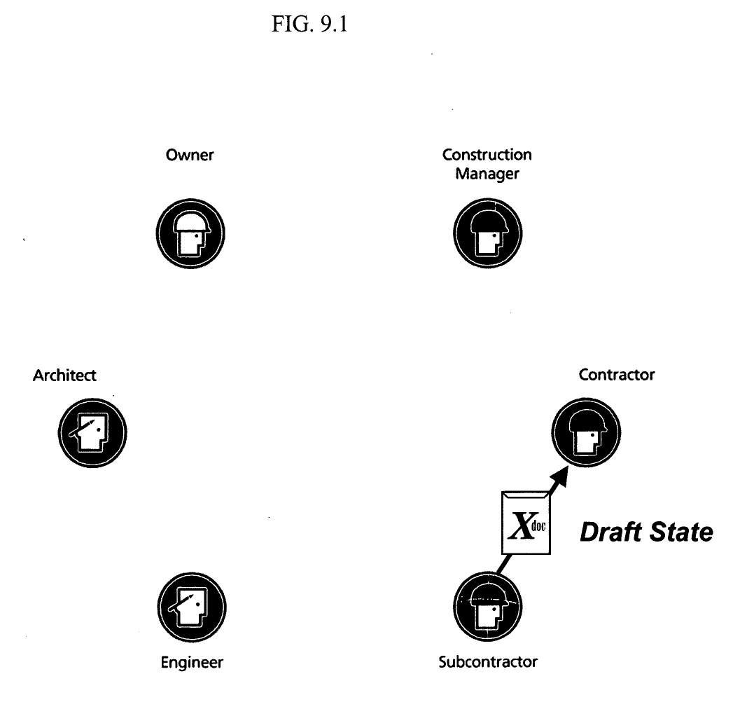

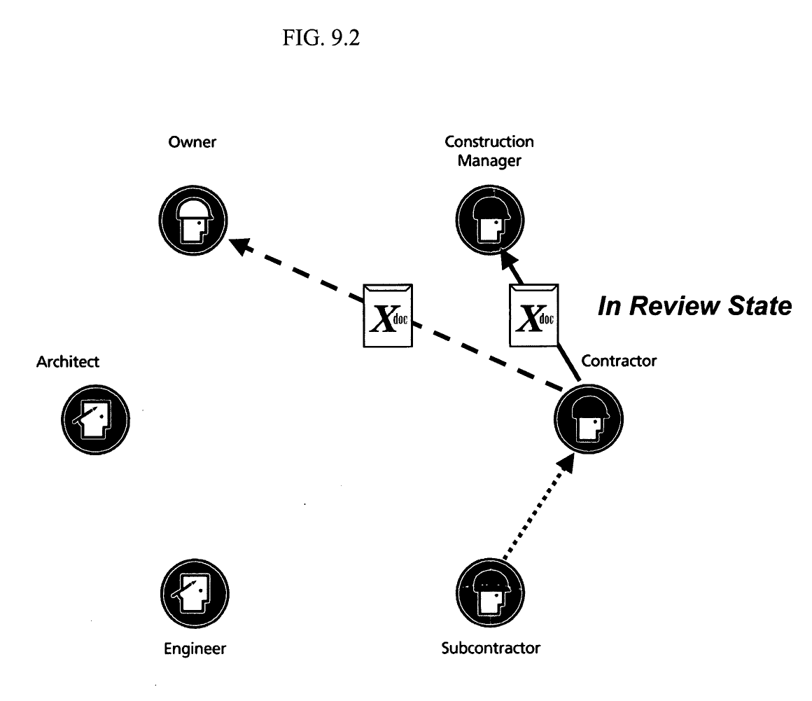

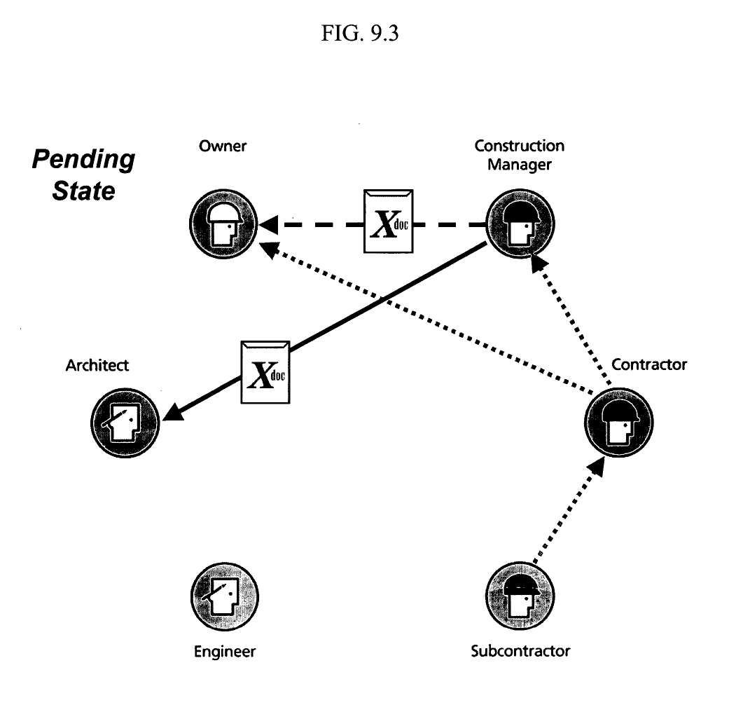

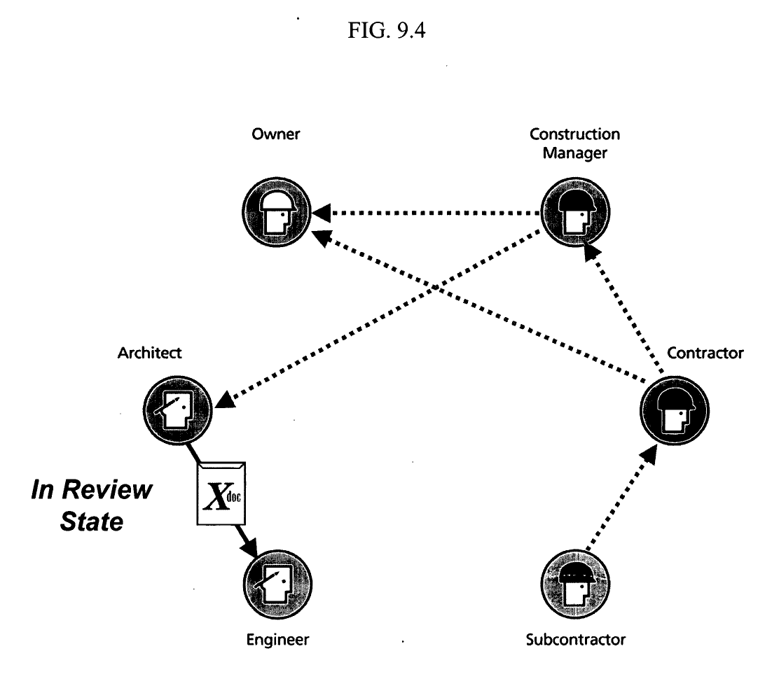

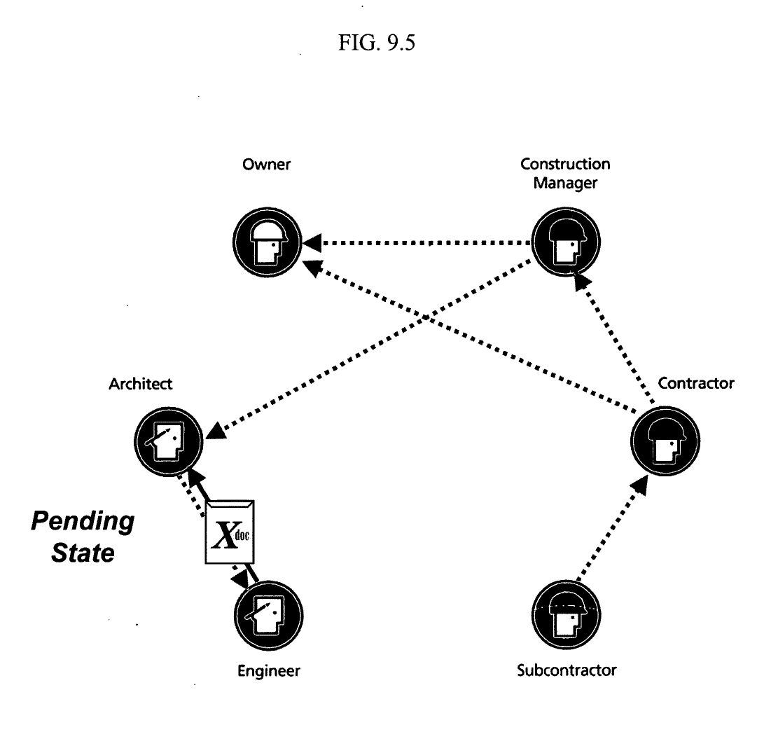

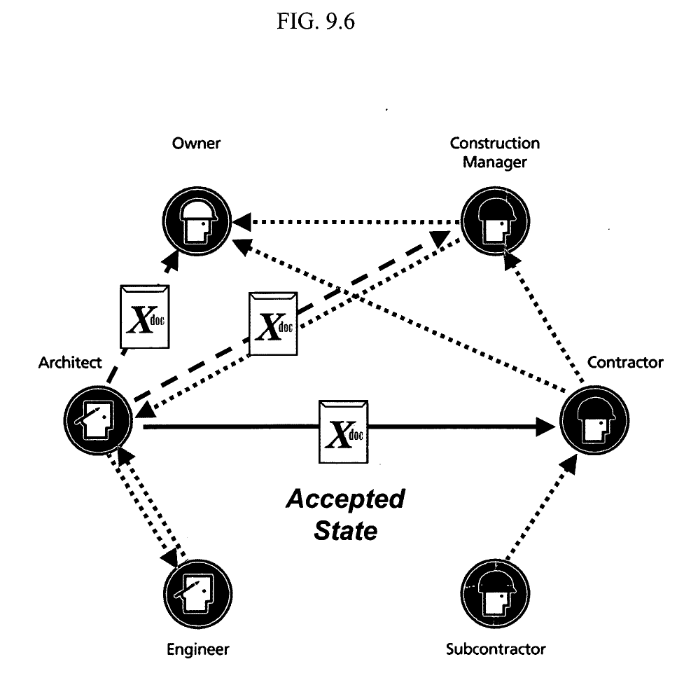

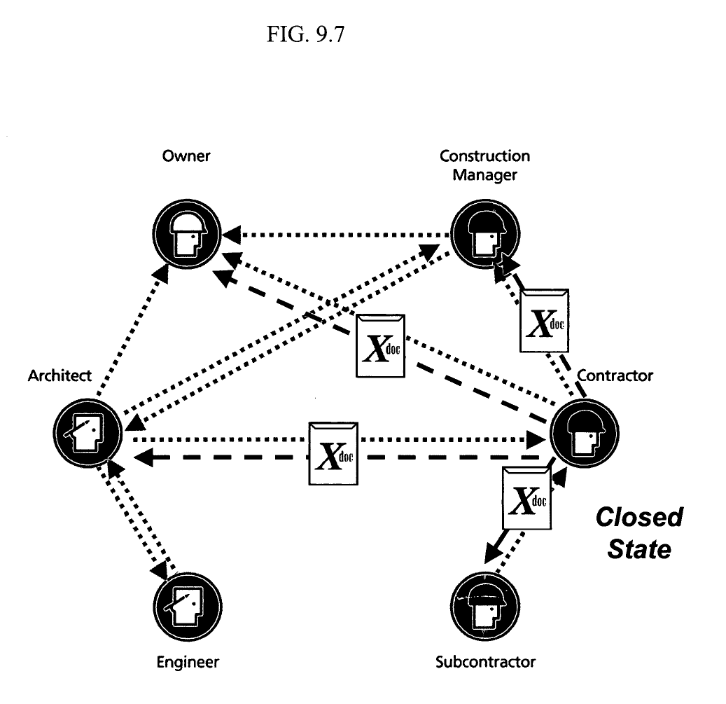

FIG. 8 is an illustration that shows an example of a Document, labeled in the illustration as an ‘Xdoc’, and is an example of a Document as described in FIG. 1. The illustrations shows the states the Document can travel through in the mechanism as detailed in FIG. 2. The state transition is indicated by a diamond shape on the illustration. The example Document states are used in the FIG. 9.1 through FIG. 9.7 example series. The illustration of FIG. 8 shows that this Document goes through the following states of Draft, Pending, In Review, Accepted and Closed. The lines between the states indicate that the Document is Distributed for these state transition ‘actions’ as detailed in FIG. 4. The user who receives the Document at each state can decide what action to perform on it. For example, the Document may go from ‘Pending’ to ‘Accepted’ or from ‘Pending’ to ‘In Review’ dependant of if the user decides that the Document is ready for consideration to becoming ‘Accepted’. In this example the document can be thought of as a construction project's architectural planning drawing that needs to be sent to different users in separate systems for reviewing and approval. FIG. 7 shows an example of how separate systems and separate companies collaborate around Documents where, as explained previously, the contractor is Acme Construction, the architect is NCC Architects, a subcontractor is Wilson Electrical and the owner is Carter's Coffee.

FIGS. 9.1 to 9.2 illustrate an example of the Document states as it is communicated from user to user. The Users are represented by their job roles where they receive Documents, illustrated as Xdocs. The solid line shows where a Document is sent to a User to perform a state transition from one Document State to another. The dashed lines indicate that the document is sent to the User for review. The dotted lines indicate where the Document has been sent already. The following steps are provided as an example of how a Document is used with the system and incorporates an example of the system as shown in FIGS. 1 through 7:

Step 1. FIG. 9.1 describes how the Document is created in a Draft state by a Sub Contractor on the Carter's Denver coffee shop store. In this example the Sub Contractor requires a clarification to a construction architectural drawing regarding a change to a building's electrical system installation. The Sub Contractor sends the Document with details of the required clarification to the Contractor on the project. Both users are on the system owned by Acme Construction.

Step 2. FIG. 9.2 describes how the Document is sent from the Contractor to the Construction Manager with the requested action to place the Document in the “In Review” state. The Contractor and the Construction Manager are both users with the Acme Construction Company's system. The Contractor also sends the Document to the Owner at Carter's Coffee, although this is just for information and requires no action.

Step 3. FIG. 9.3 describes how the Document is sent from the Construction Manager to the construction project's Architect at NCC Architects. Again, the Owner at Carter's Coffee is sent a copy of the Document for information tracking purposes. The Document is marked as in the “Pending” state, as it requires more detailed review before any action can take place with the clarification.

Step 4. FIG. 9.4 describes how the Document is sent from the Architect at NCC Architects to an Engineer at the Wilson Electrical Company. The Document is marked as “In Review” to indicate that the recipient should review the clarification request and complete the required information for the Document in this state.

Step 5. FIG. 9.5 describes how the Document is sent back from the Engineer at Wilson Electrical to the Architect at NCC Architects in the “Pending” state. The Engineer has updated the Document with the information required to enter the Pending state, which should answer the Sub Contractors original clarification request.

Step 6. FIG. 9.6 describes how the Document is sent to the Contractor in the “Accepted” state to indicate to the user at Acme Construction that the drawing update is approved and the clarification should proceed. The Owner at Carter's Coffee and the Construction Manager and ACME Construction are sent copies of the Document for information purposes.

Step 7. FIG. 9.7 describes how the Document is sent to the Sub Contractor by the Contractor in the requested action to “Close” the Document to indicate that the clarification can be considered finished. The Contractor also sends copies of the Document to the Construction Manager, Owner and Architect to let them know the original request is now completed.

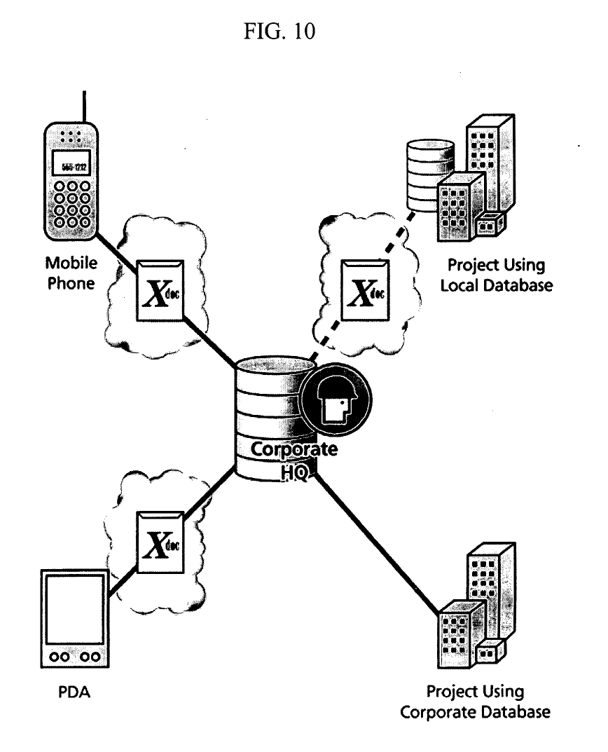

FIG. 10 is an illustration that describes in an example the methods of Document communication that are typically involved in sending and receiving information. The system incorporates various computing devices to receive and send the Document information. The Document as detailed in FIG. 1, illustrated here as an “Xdoc”, can be sent to systems as detailed in FIG. 6. The Document is transmitted and received as data as described in an extensible markup language document, also known as the World Wide Web Consortium (WC3) XML 1.0 standard, to systems running on various devices. Other languages can be used as well. The devices include Mobile Phones, hand-held computers used as Personal Digital Assistants (PDA) and Personal Computer systems either owned by the users or held by third parties and supplied as a paid-for service. The illustration shows that the system may be a number of different computing devices but which core capabilities are all the same in respect of the systems operation as detailed in FIG. 6. The Document may be communicated to the various systems through a Local Area Network or through a public Wide Area Network such as the Internet or other appropriate networks.

1. The combination of:
a first signal for storage in and operation upon by a system, said first signal representing a document of a particular type, each document type including data elements to be completed by entering information into said document, said first signal capable of having a number of states and transmissible over transmission circuits between distributed people and distributed computer systems for collaborating in completing said document; and
a second signal associated with said first signal for storage in and operation by a system, said second signal representing a task notice specifying a series of tasks to be completed to progress said first signal through said states.

2. The combination of:
a first signal for storage in and operation upon by a system, said first signal representing a document to be completed by entering information into said document, said first signal capable of having a number of states and transmissible over transmission circuits between distributed people and distributed computer systems for collaborating in completing said document, and a second signal for storage in and operation upon by a system, wherein
said first signal comprises:
a first plurality of signal portions representing a document type as a structured template specifying information to be entered into the document, and
a second plurality of signal portions representing a series of configuration templates for managing system rules to apply to the document, said configuration templates comprising a hierarchy of business rules and configurations that allow the user of said system to configure said system to provide for said distributed people and distributed computer systems processing information to complete said document, wherein
said second signal comprises:
a signal representing a task notice specifying a series of tasks to be completed to progress said signal through said states.

3. The combination of claim 2, said states having transitions and said first signal further representing a series of business workflow rules of said document, said first signal starting in an initial state and being moved to a new state by a computing device operating upon document elements in said document, through a state transition representing a business processing step performed on said document.

4. The combination of claim 3 wherein a computing device checks to determine whether said state transition is a valid transition and, if so, enables said first signal to leave said initial state and enter a new state.

5. The combination of claim 4 wherein said system includes system resources at least some of said resources storing system business rules spanning a number of Document Types for maintaining a set of high level business process rules that span a number of discrete business processes at the document level, and said computing device checks said state to determine:
whether the resource that initiated the action to request said state transition has the security privileges to do so;
whether the various document elements that are marked as required for the proposed state are completed;
whether the various document elements within the document data conform to the business rules that have been setup in the system for the industries to which the document pertains; and
whether the System Business Rules to which said system has been configured are met for said state transition.

6. The combination of claim 2, said first signal further including a third signal portion representing a document template, said third signal portion used by a computing device to check that an undertaken process step is a valid business process step.

7. The combination of claim 6 wherein said document template represents (a) a set of rules to apply for all states and (b) a series of rules to apply for each state.

8. The combination of claim 7 wherein said rules to apply for each state override the rules to apply for all states.

9. The combination of claim 8 wherein said document template includes a ‘Purchase Amount’ Document Field, said ‘Purchase Amount’ document field marked as ‘Required’ for said document to enter a ‘Purchase Approved’ state, said document failing to enter into said ‘Purchase Approved’ state until said ‘Purchase Amount’ field is completed.

10. The combination of claim 8 wherein said document template includes Document Fields marked with rules for each Document Type element, there being for each Document Type Element a corresponding set of Document Template rules stored in said system for use during a state transition.

11. The combination of claim 10 wherein said Document Template rules include:
a first rule to determine whether the Document Type Element is used by the system;
a second rule to describe the Document Type Element's data type;
a third rule to determine whether the Document Type Element is required;
a fourth rule to determine whether the Document Element is allowed to be changed or not;
a fifth rule describing the security role required for performing a reading function; and
a sixth rule describing the security role required for performing a writing function.

12. The combination of claim 11 wherein said rules are applied in the sequence set forth.

13. The combination of claim 1 wherein said states have transitions and additional information is provided with said second signal as needed for transitioning said signal between said first state and said second state, said additional information representing workflow collaboration in completing said document, said additional information capable of being detected and executed by said user or by a computing device in said external system for determining required steps to process said first signal.

14. The combination of claim 13 wherein said elements include:
a first value describing the user or the external system to receive the Document in said first state;
a second value describing who has sent said task notice requesting said transition from said first state to said second state;
a third value for setting additional information providing context on why said first signal should transition from said first state to said second state, and further providing any desired free-form information desired to facilitate said transition;
a fourth value describing that the next state to which said first signal is to be moved;
a fifth value describing a date by which said transition should take place, said fifth value for tracking the progress of Document processing or for reporting and analyzing progress of Documents through a business process; and
a sixth value describing the importance or severity associated by the system to said state transition.

15. The combination of claim 1 wherein said system organizes said business process rules in a Configuration Template Hierarchy.

16. The combination of claim 15 wherein said Configuration Template Hierarchy comprises (a) a hierarchy of related levels of configuration templates and (b) a number of Document State Templates that can be organized into larger grouping of concepts of the Document Templates, said larger grouping of concepts being held in Service Templates.

17. The combination of claim 16 wherein said Configuration Template Hierarchy includes at least signals representing document states and comprises:
a first configuration template level for system-wide data providing default settings and rules data applied through said system;
a second configuration template level providing Application Templates for default rules and settings for data in specific business applications provided in said system;
a third configuration template level providing Account Templates specifying default rules and settings for the data in the specific accounts representing a collection of Documents related to a particular project;
a fourth configuration template level providing Document Service Templates specifying default rules and settings for data in a particular Document Service representing a group of functionality regarding particular Document Types relating to a group of Documents within an account;
a fifth configuration template level providing Document Templates specifying rules and settings for a Document Type; and
a sixth configuration template level providing Document State Templates specifying rules and settings for a particular one of said Document states.

18. A system configured for operating upon documents for one or more projects, said document to be completed by entering information into said document, said system configured for establishing default rules and process to be followed by users of said system, said system transmitting and operating upon a signal representing said documents, said signal capable of having a number of states with state transitions and transmissible between distributed people and distributed computer systems for collaborating in completing said documents, said signal comprising:
a first signal portion representing series of Document Types stored and recognized by a computing device and used to identify what semantic meaning should be attached to information entered into said documents;
a second signal portion representing a Visual Identifier Caption for enabling a computing device to identify and use said signal as it proceeds to and from various of said people and systems;
a third signal portion representing a Category Caption for enabling a computing device to present information into said signal as a series of field values, one of said field values being an enumerated look up value chosen from a configurable list of acceptable data values for providing consistency of information entry into said signal.

19. The system of claim 18 wherein said signal further includes a fourth signal portion representing a specialized field value comprising a structured subset of information to be entered into said signal where said signal requires an undetermined series of values.

20. The system of claim 18 said system including one or more Business Applications that relate to the real estate, design, construction, facility management or similar industries, said Business Applications containing one or more Accounts of Document data to be processed by a set of Document Services, said system transmitting said signals by exporting said signals with a first Document Service from a first Account over a Local Area Network or Wide Area Network to an external system, said signal capable of being imported to said external system via said Document Service into a second Account to store a copy of the document in said external system.

21. The system of claim 18 wherein said signal is exported via a second Document Service from a second Account over a Local Area Network or Wide Area Network to an external system, said signal capable of being imported by an external system via a first Document Service Interface to store a copy of the signal in said external system.

22. The system of claim 18 wherein said signal can be transmitted via a first document service in said system, said signal being transferred between accounts within said system.

23. The combination of claims 1 or 2 wherein said system includes computing devices including all or any of mobile phone, hand-held computers, personal computers and workstations.

24. The system of claim 18 wherein said computing device can be all or any of a mobile phone, a hand-held computer, a personal computer and a workstation.

25. The method of distributing a combination of a first signal for storage in and operation upon by a system, said first signal representing a document of a particular type, each document type including data elements to be completed by entering information into said document, said first signal capable of having a number of states and transmissible over transmission circuits between distributed people and distributed computer systems for collaborating in completing said document; and a second signal associated with said first signal for storage in and operation by a system, said second signal representing a task notice specifying a series of tasks to be completed to progress said first signal through said states, wherein said combination of signals belongs in four separate entity systems said process including:
said combination being sent and received, respectively, to and by, users of a plurality of separate service entity systems, said users collaborating on a single project, said collaborating including collaboratively completing said series of tasks, each separate service entity system maintaining a copy of said combination of signals in storage in said separate service entity system.

26. The method of claim 25 wherein said first signal in said combination of signals goes through the states of Draft, Pending, In Review, Accepted and Closed.

27. The method of claim 26 wherein said combination of signals is distributed to at least some of said service entity systems for operating on said first signal to progress said first signal from a first state to a second state.

28. The method of claim 27 wherein a user of a separate service provider system receiving said combination of signals can perform transition actions on said first signal.

29. The method of claim 26 wherein said document is a document used in a construction project to be sent to users of said independent service entity systems for review and approval.

30. The method of claim 29 wherein said document is an architectural document.

31. The method of claim 26 wherein said combination of signals is created by a subcontractor on a project, said subcontractor marking said second signal as in the Draft State, said second signal including details of a required clarification, to a contractor on said project.

32. The method of claim 31 wherein said combination of signals is sent from said construction manager using a first service entity system to an architect using a second service entity system, said construction manager marking said second signal as in the Pending state indicating that more detailed review is required before said clarification is completed.

33. The method of claim 32 wherein said combination of signals is sent from said architect to an engineer using a third service provider system, said second signal being marked as being in the In Review state by said architect to indicate that said engineer should review the clarification request and complete required information for the In Review state.

34. The method of claim 33 wherein said combination of signals is sent from said engineer to said architect, said engineer marking said second signal as in the Pending state indicating that clarification has take place and its sufficiency should be reviewed.

35. The method of claim 34 wherein said combination of signals is sent from said architect to said contractor, said architect marking said second signal as in the Accepted state to indicate that said clarification is sufficient.

36. The method of claim 35 wherein said combination of signals is sent from said contractor to said subcontractor, said contractor marking said second signal as in the Closed state to indicate that said action required for state transition is complete.

37. The method of providing:
a first signal for storage in and operation upon by a system, said first signal representing a document of a particular type, each document type including data elements to be completed by entering information into said document, said first signal capable of having a number of states and transmissible over transmission circuits between distributed people and distributed computer systems for collaborating in completing said document; and
a second signal associated with said first signal for storage in and operation by a system, said second signal representing a task notice specifying a series of tasks to be completed to progress said first signal through said states.

38. The method of providing:
a first signal for storage in and operation upon by a system, said first signal representing a document to be completed by entering information into said document, said first signal capable of having a number of states and transmissible over transmission circuits between distributed people and distributed computer systems for collaborating in completing said document, and a second signal for storage in and operation upon by a system, wherein
said first signal comprises:
a first plurality of signal portions representing a document type as a structured template specifying information to be entered into the document, and
a second plurality of signal portions representing a series of configuration templates for managing system rules to apply to the document, said configuration templates comprising a hierarchy of business rules and configurations that allow the user of said system to configure said system to provide for said distributed people and distributed computer systems processing information to complete said document, wherein
said second signal comprises:
a signal representing a task notice specifying a series of tasks to be completed to progress said signal through said states.

39. The method of claim 38, said states having transitions and said first signal further representing a series of business workflow rules of said document, said first signal starting in an initial state and being moved to a new state by a computing device operating upon document elements in said document, through a state transition representing a business processing step performed on said document.

40. The method of claim 39 wherein a computing device checks to determine whether said state transition is a valid transition and, if so, enables said first signal to leave said initial state and enter a new state.

41. The method of claim 40 wherein said system includes system resources at least some of said resources storing system business rules spanning a number of Document Types for maintaining a set of high level business process rules that span a number of discrete business processes at the document level, and said computing device checks said state to determine:
whether the resource that initiated the action to request said state transition has the security privileges to do so;
whether the various document elements that are marked as required for the proposed state are completed;
whether the various document elements within the document data conform to the business rules that have been setup in the system for the industries to which the document pertains; and
whether the System Business Rules to which said system has been configured are met for said state transition.

42. The method of claim 38, said first signal further including a third signal portion representing a document template, said third signal portion used by a computing device to check that an undertaken process step is a valid business process step.

43. The method of claim 42 wherein said document template represents (a) a set of rules to apply for all states and (b) a series of rules to apply for each state.

44. The method of claim 43 wherein said rules to apply for each state override the rules to apply for all states.

45. The method of claim 44 wherein said document template includes a ‘Purchase Amount’ Document Field, said ‘Purchase Amount’ document field marked as ‘Required’ for said document to enter a ‘Purchase Approved’ state, said document failing to enter into said ‘Purchase Approved’ state until said ‘Purchase Amount’ field is completed.

46. The method of claim 44 wherein said document template includes Document Fields marked with rules for each Document Type element, there being for each Document Type Element a corresponding set of Document Template rules stored in said system for use during a state transition.

47. The method of claim 46 wherein said Document Template rules include:
a first rule to determine whether the Document Type Element is used by the system;
a second rule to describe the Document Type Element's data type;
a third rule to determine whether the Document Type Element is required;
a fourth rule to determine whether the Document Element is allowed to be changed or not;
a fifth rule describing the security role required for performing a reading function; and
a sixth rule describing the security role required for performing a writing function.

48. The method of claim 47 wherein said rules are applied in the sequence set forth.

49. The method of claim 37 wherein said states have transitions and additional information is provided with said second signal as needed for transitioning said signal between said first state and said second state, said additional information representing workflow collaboration in completing said document, said additional information capable of being detected and executed by said user or by a computing device in said external system for determining required steps to process said first signal.

50. The method of claim 49 wherein said elements include:
a first value describing the user or the external system to receive the Document in said first state;
a second value describing who has sent said task notice requesting said transition from said first state to said second state;
a third value for setting additional information providing context on why said first signal should transition from said first state to said second state, and further providing any desired free-form information desired to facilitate said transition;
a fourth value describing that the next state to which said first signal is to be moved;
a fifth value describing a date by which said transition should take place, said fifth value for tracking the progress of Document processing or for reporting and analyzing progress of Documents through a business process; and
a sixth value describing the importance or severity associated by the system to said state transition.

51. The method of claim 37 wherein said system organizes said business process rules in a Configuration Template Hierarchy.

52. The method of claim 51 wherein said Configuration Template Hierarchy comprises (a) a hierarchy of related levels of configuration templates and (b) a number of Document State Templates that can be organized into larger grouping of concepts of the Document Templates, said larger grouping of concepts being held in Service Templates.

53. The method of claim 52 wherein said Configuration Template Hierarchy includes at least signals representing document states and comprises:
a first configuration template level for system-wide data providing default settings and rules data applied through said system;
a second configuration template level providing Application Templates for default rules and settings for data in specific business applications provided in said system;
a third configuration template level providing Account Templates specifying default rules and settings for the data in the specific accounts representing a collection of Documents related to a particular project;
a fourth configuration template level providing Document Service Templates specifying default rules and settings for data in a particular Document Service representing a group of functionality regarding particular Document Types relating to a group of Documents within an account;
a fifth configuration template level providing Document Templates specifying rules and settings for a Document Type; and
a sixth configuration template level providing Document State Templates specifying rules and settings for a particular one of said Document states.

54. A method of providing a system configured for operating upon documents for one or more projects, said document to be completed by entering information into said document, said system configured for establishing default rules and process to be followed by users of said system, said system transmitting and operating upon a signal representing said documents, said signal capable of having a number of states with state transitions and transmissible between distributed people and distributed computer systems for collaborating in completing said documents, said signal comprising:
a first signal portion representing series of Document Types stored and recognized by a computing device and used to identify what semantic meaning should be attached to information entered into said documents;
a second signal portion representing a Visual Identifier Caption for enabling a computing device to identify and use said signal as it proceeds to and from various of said people and systems;
a third signal portion representing a Category Caption for enabling a computing device to present information into said signal as a series of field values, one of said field values being an enumerated look up value chosen from a configurable list of acceptable data values for providing consistency of information entry into said signal.

55. The method of claim 54 wherein said signal further includes a fourth signal portion representing a specialized field value comprising a structured subset of information to be entered into said signal where said signal requires an undetermined series of values.

56. The method of claim 54 said system including one or more Business Applications that relate to the real estate, design, construction, facility management or similar industries, said Business Applications containing one or more Accounts of Document data to be processed by a set of Document Services, said system transmitting said signals by exporting said signals with a first Document Service from a first Account over a Local Area Network or Wide Area Network to an external system, said signal capable of being imported to said external system via said Document Service into a second Account to store a copy of the document in said external system.

57. The method of claim 54 wherein said signal is exported via a second Document Service from a second Account over a Local Area Network or Wide Area Network to an external system, said signal capable of being imported by an external system via a first Document Service Interface to store a copy of the signal in said external system.

58. The method of claim 54 wherein said signal can be transmitted via a first document service in said system, said signal being transferred between accounts within said system.

59. One or more processor readable storage devices having processor readable code embodied on said processor readable storage devices, said processor readable code for programming one or more processors to perform a method of distributing a combination of a first signal for storage in and operation upon by a system, said first signal representing a document of a particular type, each document type including data elements to be completed by entering information into said document, said first signal capable of having a number of states and transmissible over transmission circuits between distributed people and distributed computer systems for collaborating in completing said document; and a second signal associated with said first signal for storage in and operation by a system, said second signal representing a task notice specifying a series of tasks to be completed to progress said first signal through said states, wherein said combination of signals belongs in four separate entity systems said process including:
said combination being sent and received, respectively, to and by, users of a plurality of separate service entity systems, said users collaborating on a single project, said collaborating including collaboratively completing said series of tasks, each separate service entity system maintaining a copy of said combination of signals in storage in said separate service entity system.

60. The one or more processor readable storage devices of claim 59 wherein said first signal in said combination of signals goes through the states of Draft, Pending, In Review, Accepted and Closed.

61. The one or more processor readable storage devices of claim 60 wherein said combination of signals is distributed to at least some of said service entity systems for operating on said first signal to progress said first signal from a first state to a second state.

62. The one or more processor readable storage devices of claim 61 wherein a user of a separate service provider system receiving said combination of signals can perform transition actions on said first signal.

63. The one or more processor readable storage devices of claim 60 wherein said document is a document used in a construction project to be sent to users of said independent service entity systems for review and approval.

64. The one or more processor readable storage devices of claim 63 wherein said document is an architectural document.

65. The one or more processor readable storage devices of claim 60 wherein said combination of signals is created by a subcontractor on a project, said subcontractor marking said second signal as in the Draft State, said second signal including details of a required clarification, to a contractor on said project.

66. The one or more processor readable storage devices of claim 65 wherein said combination of signals is sent from said construction manager using a first service entity system to an architect using a second service entity system, said construction manager marking said second signal as in the Pending state indicating that more detailed review is required before said clarification is completed.

67. The one or more processor readable storage devices of claim 66 wherein said combination of signals is sent from said architect to an engineer using a third service provider system, said second signal being marked as being in the In Review state by said architect to indicate that said engineer should review the clarification request and complete required information for the In Review state.

68. The one or more processor readable storage devices of claim 67 wherein said combination of signals is sent from said engineer to said architect, said engineer marking said second signal as in the Pending state indicating that clarification has take place and its sufficiency should be reviewed.

69. The one or more processor readable storage devices of claim 68 wherein said combination of signals is sent from said architect to said contractor, said architect marking said second signal as in the Accepted state to indicate that said clarification is sufficient.

70. The one or more processor readable storage devices of claim 69 wherein said combination of signals is sent from said contractor to said subcontractor, said contractor marking said second signal as in the Closed state to indicate that said action required for state transition is complete.

71. One or more processor readable storage devices having processor readable code embodied on said processor readable storage devices, said processor readable code for programming one or more processors to perform a method of providing:
a first signal for storage in and operation upon by a system, said first signal representing a document of a particular type, each document type including data elements to be completed by entering information into said document, said first signal capable of having a number of states and transmissible over transmission circuits between distributed people and distributed computer systems for collaborating in completing said document; and
a second signal associated with said first signal for storage in and operation by a system, said second signal representing a task notice specifying a series of tasks to be completed to progress said first signal through said states.

72. One or more processor readable storage devices having processor readable code embodied on said processor readable storage devices, said processor readable code for programming one or more processors to perform a method of providing:
a first signal for storage in and operation upon by a system, said first signal representing a document to be completed by entering information into said document, said first signal capable of having a number of states and transmissible over transmission circuits between distributed people and distributed computer systems for collaborating in completing said document, and a second signal for storage in and operation upon by a system, wherein
said first signal comprises:
a first plurality of signal portions representing a document type as a structured template specifying information to be entered into the document, and
a second plurality of signal portions representing a series of configuration templates for managing system rules to apply to the document, said configuration templates comprising a hierarchy of business rules and configurations that allow the user of said system to configure said system to provide for said distributed people and distributed computer systems processing information to complete said document, wherein
said second signal comprises:
a signal representing a task notice specifying a series of tasks to be completed to progress said signal through said states.

73. The one or more processor readable storage devices of claim 72, said states having transitions and said first signal further representing a series of business workflow rules of said document, said first signal starting in an initial state and being moved to a new state by a computing device operating upon document elements in said document, through a state transition representing a business processing step performed on said document.

74. The one or more processor readable storage devices of claim 73 wherein a computing device checks to determine whether said state transition is a valid transition and, if so, enables said first signal to leave said initial state and enter a new state.

75. The one or more processor readable storage devices of claim 74 wherein said system includes system resources at least some of said resources storing system business rules spanning a number of Document Types for maintaining a set of high level business process rules that span a number of discrete business processes at the document level, and said computing device checks said state to determine:
whether the resource that initiated the action to request said state transition has the security privileges to do so;
whether the various document elements that are marked as required for the proposed state are completed;
whether the various document elements within the document data conform to the business rules that have been setup in the system for the industries to which the document pertains; and
whether the System Business Rules to which said system has been configured are met for said state transition.

76. The one or more processor readable storage devices of claim 72, said first signal further including a third signal portion representing a document template, said third signal portion used by a computing device to check that an undertaken process step is a valid business process step.

77. The one or more processor readable storage devices of claim 76 wherein said document template represents (a) a set of rules to apply for all states and (b) a series of rules to apply for each state.

78. The one or more processor readable storage devices claim 77 wherein said rules to apply for each state override the rules to apply for all states.

79. The one or more processor readable storage devices claim 78 wherein said document template includes a ‘Purchase Amount’ Document Field, said ‘Purchase Amount’ document field marked as ‘Required’ for said document to enter a ‘Purchase Approved’ state, said document failing to enter into said ‘Purchase Approved’ state until said ‘Purchase Amount’ field is completed.

80. The one or more processor readable storage devices of claim 78 wherein said document template includes Document Fields marked with rules for each Document Type element, there being for each Document Type Element a corresponding set of Document Template rules stored in said system for use during a state transition.

81. The one or more processor readable storage devices of claim 80 wherein said Document Template rules include:
a first rule to determine whether the Document Type Element is used by the system;
a second rule to describe the Document Type Element's data type;
a third rule to determine whether the Document Type Element is required;
a fourth rule to determine whether the Document Element is allowed to be changed or not;
a fifth rule describing the security role required for performing a reading function; and
a sixth rule describing the security role required for performing a writing function.

82. The one or more processor readable storage devices of claim 81 wherein said rules are applied in the sequence set forth.

83. The one or more processor readable storage devices of claim 71 wherein said states have transitions and additional information is provided with said second signal as needed for transitioning said signal between said first state and said second state, said additional information representing workflow collaboration in completing said document, said additional information capable of being detected and executed by said user or by a computing device in said external system for determining required steps to process said first signal.

84. The one or more processor readable storage devices of claim 83 wherein said elements include:
a first value describing the user or the external system to receive the Document in said first state;
a second value describing who has sent said task notice requesting said transition from said first state to said second state;
a third value for setting additional information providing context on why said first signal should transition from said first state to said second state, and further providing any desired free-form information desired to facilitate said transition;
a fourth value describing that the next state to which said first signal is to be moved;
a fifth value describing a date by which said transition should take place, said fifth value for tracking the progress of Document processing or for reporting and analyzing progress of Documents through a business process; and
a sixth value describing the importance or severity associated by the system to said state transition.

85. The one or more processor readable storage devices of claim 71 wherein said system organizes said business process rules in a Configuration Template Hierarchy.

86. The method of claim 85 wherein said Configuration Template Hierarchy comprises (a) a hierarchy of related levels of configuration templates and (b) a number of Document State Templates that can be organized into larger grouping of concepts of the Document Templates, said larger grouping of concepts being held in Service Templates.

87. The method of claim 86 wherein said Configuration Template Hierarchy includes at least signals representing document states and comprises:
a first configuration template level for system-wide data providing default settings and rules data applied through said system;
a second configuration template level providing Application Templates for default rules and settings for data in specific business applications provided in said system;
a third configuration template level providing Account Templates specifying default rules and settings for the data in the specific accounts representing a collection of Documents related to a particular project;
a fourth configuration template level providing Document Service Templates specifying default rules and settings for data in a particular Document Service representing a group of functionality regarding particular Document Types relating to a group of Documents within an account;
a fifth configuration template level providing Document Templates specifying rules and settings for a Document Type; and
a sixth configuration template level providing Document State Templates specifying rules and settings for a particular one of said Document states.

88. One or more processor readable storage devices having processor readable code embodied on said processor readable storage devices, said processor readable code for programming one or more processors to perform a method of providing a system configured for operating upon documents for one or more projects, said document to be completed by entering information into said document, said system configured for establishing default rules and process to be followed by users of said system, said system transmitting and operating upon a signal representing said documents, said signal capable of having a number of states with state transitions and transmissible between distributed people and distributed computer systems for collaborating in completing said documents, said signal comprising:
a first signal portion representing series of Document Types stored and recognized by a computing device and used to identify what semantic meaning should be attached to information entered into said documents;
a second signal portion representing a Visual Identifier Caption for enabling a computing device to identify and use said signal as it proceeds to and from various of said people and systems;
a third signal portion representing a Category Caption for enabling a computing device to present information into said signal as a series of field values, one of said field values being an enumerated look up value chosen from a configurable list of acceptable data values for providing consistency of information entry into said signal.

89. The one or more processor readable storage devices of claim 88 wherein said signal further includes a fourth signal portion representing a specialized field value comprising a structured subset of information to be entered into said signal where said signal requires an undetermined series of values.

90. The one or more processor readable storage devices of claim 88 said system including one or more Business Applications that relate to the real estate, design, construction, facility management or similar industries, said Business Applications containing one or more Accounts of Document data to be processed by a set of Document Services, said system transmitting said signals by exporting said signals with a first Document Service from a first Account over a Local Area Network or Wide Area Network to an external system, said signal capable of being imported to said external system via said Document Service into a second Account to store a copy of the document in said external system.

91. The one or more processor readable storage devices of claim 88 wherein said signal is exported via a second Document Service from a second Account over a Local Area Network or Wide Area Network to an external system, said signal capable of being imported by an external system via a first Document Service Interface to store a copy of the signal in said external system.

92. The one or more processor readable storage devices of claim 88 wherein said signal can be transmitted via a first document service in said system, said signal being transferred between accounts within said system.
